(19) United States
(12) Patent Application Publication
(10) Pub. No.: US 2003/0153389 A1
(43) Pub. Date: Aug. 14, 2003

(54) Torsion vibration damper

(76) Inventor: Ulrich Rohs, Duren (DE)

Correspondence Address: INTELLECTUAL PROPERTY / TECHNOLOGY LAW, PO BOX 14329, RESEARCH TRIANGLE PARK, NC, 27709, US

(21) Appl. No.: 10/350,216

(22) Filed: Jan. 23, 2002

Related U.S. Application Data
(63) Continuation of application No. 09/769,994, filed on Jan. 25, 2001, now abandoned.

(30) Foreign Application Priority Data
Jan. 19, 2001 (DE) 201 01 059.3

(51) Int. Cl. F16D 3/66

(52) U.S. Cl. 464/61

(57) ABSTRACT

A torsion vibration damper comprises a first driving module and a second driven module that are mounted on bearings and are capable of rotational movement relative to each other, wherein the first driving module comprises a primary driving plate formed by a metal sheet, and a toothed rim mounted circumferentially on the primary driving plate, wherein such toothed rim incorporates sufficient mass to yield a moment of inertia for stabilizing the primary driving plate, so that no torque-applying circumferential plate is necessary for such first driving module.

### CROSS REFERENCE TO RELATED APPLICATIONS

This is a continuation of U.S. patent application Ser. No. 09/769,994, filed on Jan. 25, 2001 under the name of Ulrich Rohs for “TORSION VIBRATION DAMPER,” which in turn claims priority to German Patent Application No. 201 01059.3 filed on Jan. 19, 2001.

### FIELD OF INVENTION

The invention relates to an improved torsion vibration damper that comprises a first driving module and a second driven module that are mounted on bearings and are capable of rotational movement relative to each other, wherein the first driving module comprises a primary driving plate formed by a metal sheet, and a toothed rim mounted circumferentially on the primary driving plate, wherein such toothed rim incorporates sufficient mass to guarantee an adequate moment of inertia for stabilizing the primary driving plate, so that no torque-applying circumferential plate is necessary for such first driving module.

### BACKGROUND OF INVENTION

In engines with clutches, it is disadvantageous if the torsional vibrations of the engine are transmitted to the drive train, particularly when the vibration frequencies are close to the inherent frequencies of the system.

In order to avoid the transmission of such torsional vibrations, torsion vibration dampers are provided between the coupling parts. Specifically, U.S. Pat. Nos. 5,863,253; 6,273,823; 6,286,390; 6,364,775; 6,416,416, all to Ulrich Rohs, describe a torsion vibration damper that comprises a first driving module and a second driven module, which are mounted on bearings and linked by a spring arrangement, so that such first and second modules can rotate in relation to each other.

The first driving module of such torsion vibration damper disclosed in Rohs' patents comprises a primary driving plate, which is formed by pressing or cold-forming a metal sheet, preferably a steel sheet, into a three-dimensional plate 1 having central drilled holes 12, nose elements 11, a circumferential angled surface 14 that raises perpendicularly above the rotational plan of the primary driving plate 1, cut-out areas 15 that interrupts the angled surface 14 and forms opposed support surface 13, and tangential friction surfaces 16 defined by the radially interior side of the angled surface 14 and the cut-out areas 15, as shown in FIG. 1.

Such primary driving plate 1 formed by pressing or cold-forming a metal sheet is particularly suitable for use in small motor vehicles that feature combustion engines with displacement of less than three liters. Use of such metal-sheet primary driving plate significantly simplifies the manufacturing process thereof, and reduces the manufacturing costs, in comparison to primary driving plates formed by casting or molding.

Usually, sufficient moment of inertia needs to be provided at the circumference of the primary driving plate so as to apply sufficient torque to such module, so as to reduce vibration. In conventional driving plates formed by casting or molding, such moment of inertia can be easily provided by casting or molding the plates with additional mass incorporated to the circumference of such plates. However, since the primary driving plate as described hereinabove is formed by pressing a single metal sheet, such plate inevitably has a substantially uniform thickness from the center to the circumference thereof, and additional mass cannot be incorporated thereinto after the processing process. As a result, the metal-sheet primary driving plate does not provide sufficient moment of inertias and torque.

The Rohs' patents solve such problem, by providing an additional torque-applying plate that can be coupled to such metal-sheet primary driving plate at its circumference, so as to provide the required moment of inertia and torque to the first driving module.

FIG. 2 therefore shows a typical first driving module disclosed by the Rohs' patents, which comprises a primary driving plate 1 formed by a metal-sheet, an additional torque-applying plate 5 that can be coupled to such primary driving plate 1 at its circumference, and a toothed rim 6 that can be coupled to such primary driving plate 1 at its circumference.

FIG. 3 shows a cross-sectional view of a specific torsion vibration damper, having a first driving module that can rotate in relation to a second driven module 2, wherein such first driving module comprises the primary driving plate 1, the additional torque-applying plate 5, and the toothed rim 6. The primary driving plate 1, formed by a metal sheet, has a thickness that is substantially uniform throughout, as shown in FIG. 3, and the additional torque-applying plate 5 adds substantial mass to the circumference of such primary driving plate 1, for providing the required moment of inertia.

FIG. 4 shows a cross-section view of the torsion vibration damper of a slightly different design, which similarly comprises a first driving module including a metal-sheet primary driving plate 1, an additional torque-applying plate 5, a toothed rim 6, and a second driven module 2. A spring chamber 7 is provided between the primary driving plate 1 and the second driven module 2, in which a spring mechanism 8 is provided.

FIG. 5 shows a cross-section view of a torsion vibration damper 20, as described in Rohs' patents used in connection with a pinion 31 of a starter engine 35, which is mounted at a housing 33. The torsion vibration damper 20 comprises a first driving module having a metal-sheet primary driving plate 21, an additional torque-applying plate 25, and a toothed rim 26. The first driving module is capable of rotational movement in relation to a second driven module 22 and is linked to such second driven module 22 by a spring arrangement 28.

The toothed rim 26 of the first driving module is able to be engaged with the pinion 31 of the starter engine 35, and such pinion 31 is capable of moving back and forth between a free position (not shown) and an engaged position, as shown in FIG. 5. When starting the engine, the pinion 31 is moved into the engaged position, so that the starter engine 35 is able to rotate the toothed rim 26 as well as the torsion vibration damper 20 itself, in order to start the engine.

There is continuing need to further improve the torsion vibration damper design, so that such torsion vibration damper can be simpler and more robust, for purpose of reducing the manufacture and maintenance costs of the motor vehicles.

### SUMMARY OF THE INVENTION AND PREFERRED EMBODIMENTS THEREOF

The present invention provides a torsion vibration damper which comprises a first driving module and a second driven module mounted on bearings and capable of rotational movement in relation to one another, wherein the first driving module consists of only a primary driving plate made of a metal sheet and having substantial uniform thickness throughout, and a toothed rim that incorporates additional mass that is sufficient to provide the moment of inertia required for such first driving module.

The first driving module of the torsion vibration damper of the present invention therefore is devoid of the additional torque-applying plate that is required for the metal-sheet primary driving plate. Such first driving module, consisting of only two parts, i.e., the metal-sheet primary driving plate and the toothed rim, is significantly simpler than that used in the torsion vibration dampers disclosed in Rohs' patents.

### BRIEF DESCRIPTION OF THE DRAWINGS

FIG. 1 shows a primary driving plate formed by pressing or cold-forming a metal sheet.

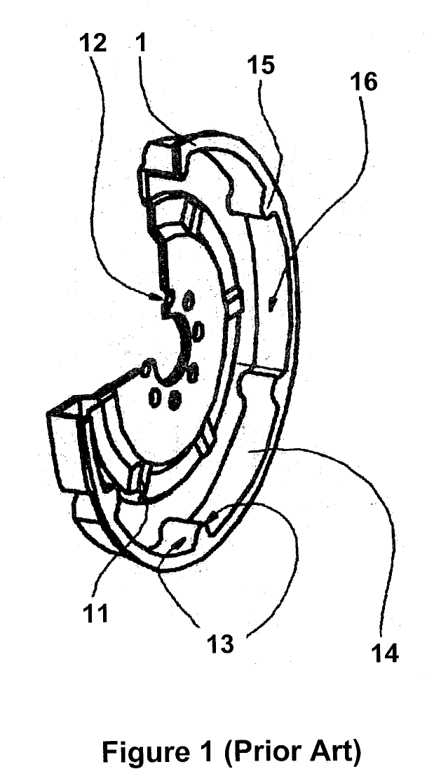

FIG. 2 shows a first driving module of a torque vibration damper, which comprises a metal-sheet primary driving plate coupled to an additional torque-applying plate and a toothed rim.

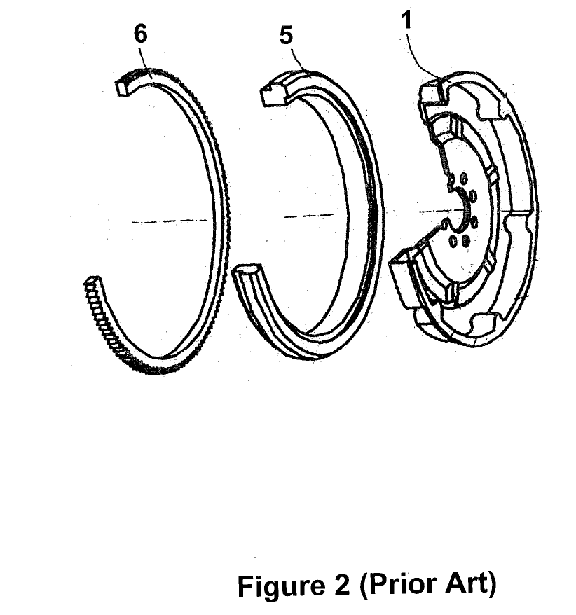

FIG. 3 shows part of a torque vibration damper of a conventional design.

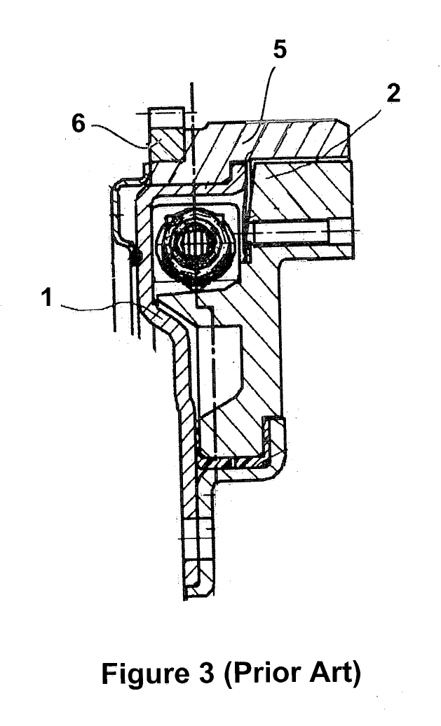

FIG. 4 shows part of a torque vibration damper of a conventional design.

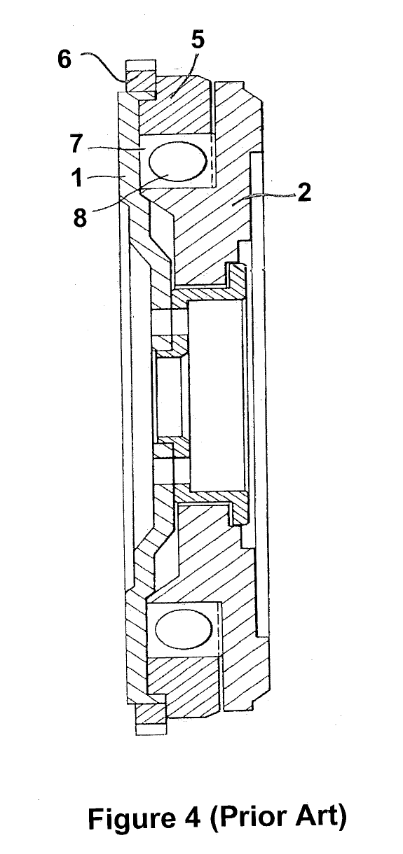

FIG. 5 shows a torque vibration damper of a convention design, coupled to a starter engine.

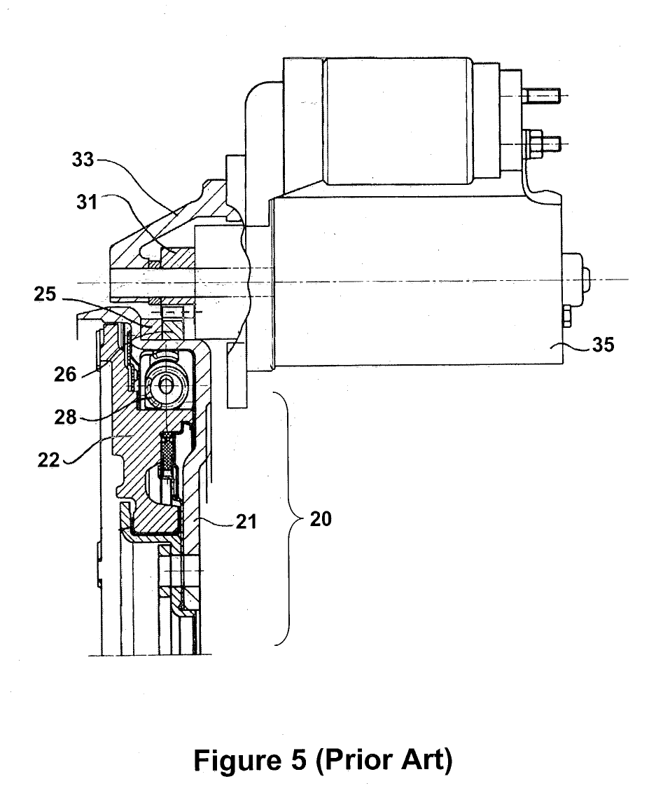

FIG. 6 shows a torque vibration damper according to one embodiment of the present invention, which is to be engaged with a starter engine.

FIG. 7 shows the torque vibration damper of FIG. 6, which is engaged with the starter engine.

### DETAILED DESCRIPTION OF THE INVENTION, AND PREFERRED EMBODIMENTS THEREOF

The present invention incorporates additional mass into the toothed rim of the first driving module, by widening the teeth of such toothed rim beyond the tooth width that is generally required for such toothed rim used in connection with smaller motor vehicle engines with displacement of three liters or less.

By doing so, the present invention achieves the goal of providing the required moment of inertia to the first driving module, without use an additional torque-applying plate. Because the toothed rim is coupled to the metal-sheet primary driving plate at the circumference of such plate, a slight addition of mass into such toothed rim provides sufficient torque for stabilizing the first driving module, and the torque-applying plate disclosed by the Rohs' patents is no longer necessary.

Therefore, the widened toothed rim performs not only the primary function of engaging the pinion of a starter engine, but also a secondary function of providing the required moment of inertia and torque to the metal-sheet primary driving plate. By means of this invention, the number of components necessary for the torsion vibration damper can be reduced, so that the torsion vibration damper can be manufactured substantially more economically.

The toothed rim of the present invention is preferably designed herein to be wider than 12 mm, more preferably wider than 13 mm, and most preferably wider than 14 mm. The invention is manifested particularly clearly if the toothed rim is designed to be wider than 15 mm, 16 mm, or 17 mm, respectively.

The ratio of the tooth width of such toothed rim to the tooth height thereof is preferably greater than 1, more preferably greater than 1.1, and most preferably greater than 1.2.

The ratio of the tooth width of such toothed rim to the overall diameter of such toothed rim is preferably greater than 0.05 and more preferably greater than 0.052. In this respect the invention is manifested particularly clearly if this ratio is greater thin 0.053, 0.055, or 0.058, respectively.

The present invention, by designing the toothed rim wider than necessary or required, provides an easy and economic way to apply the required moment of inertia to the driving module. The additional mass, which must otherwise be secured to the metal-sheet primary plate of the torsion vibration damper in form of an additional torque-applying plate, is incorporated therefore into the toothed rim, and significantly simplifies the design of such torsion vibration damper.

The widening of the toothed rim in relation to conventional toothed rims also has the advantage of providing a greater installation tolerance with regard to the pinion of the starter engine, so that the size of this pinion in relation to known starter pinions, which are normally chosen to be relatively wide in order to guarantee adequate installation tolerance can be selected as substantially smaller. This allows for costs to be reduced still further.

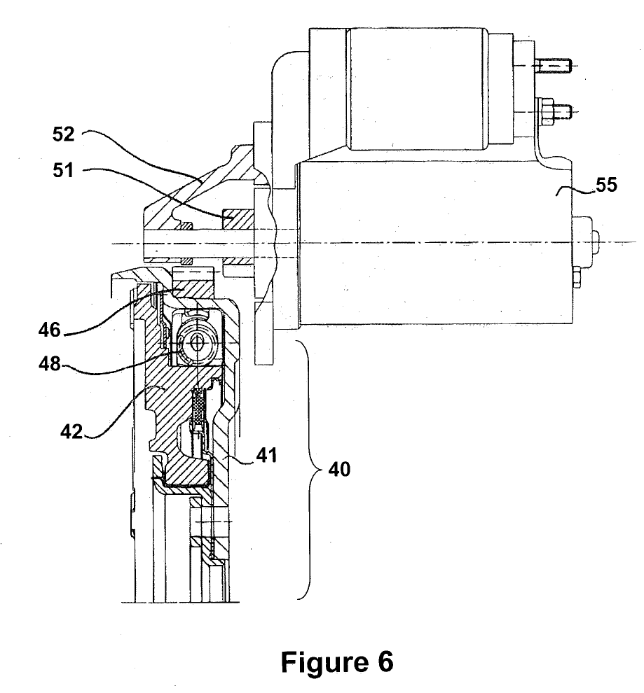

FIG. 6 shows a torsion vibration damper 40 adjacent to a starter engine 55 disposed in a housing 52, wherein the pinion 51 of such starter engine 55 is in a free position.

The torsion vibration damper 40 comprises a first driving module consisting of a primary driving plate 41 formed of a metal sheet coupled with a widened toothed rim 46, and a second driven module 42 linked to such first driving module by a spring arrangement 48.

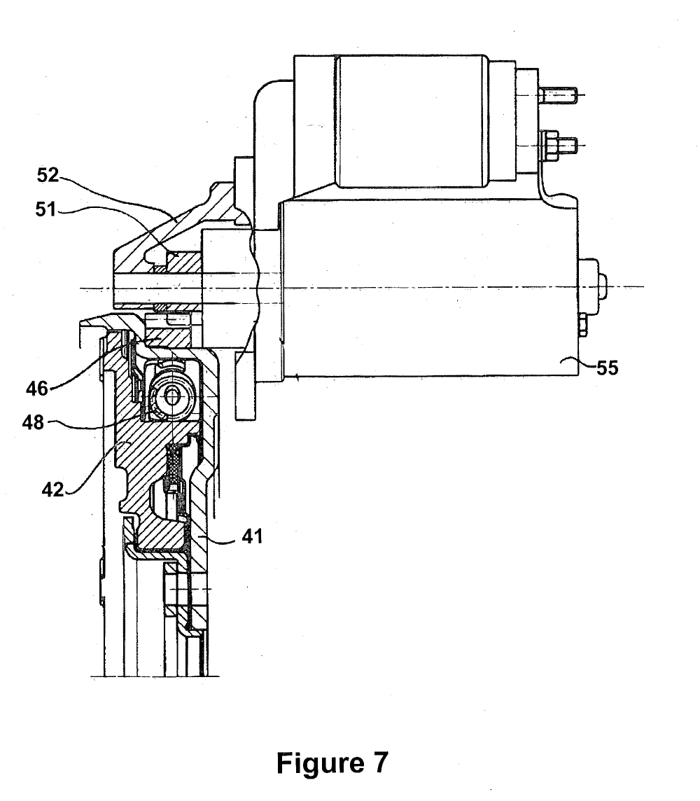

FIG. 7 shows that the pinion 51 of the starter engine 55 is moved to an engaged position, engaging the widened toothed rim 46 of the torsion vibration damper 40, for starting the engine.

The torsion vibration damper according to this embodiment is designed for a motor vehicle with a combustion engine, which features a displacement of less than 3 liters.

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

1. A torsion vibration damper comprising a first driving module and a second driven module mounted on bearings and capable of rotational movement relative to each other, wherein the first driving module consists of a primary driving plate formed by a metal sheet, and a toothed rim mounted circumferentially on the primary driving plate, wherein said toothed rim incorporates sufficient mass to yield a moment of inertia for stabilization of said first driving module.

2. The torsion vibration damper of claim 1, wherein said first driving module is devoid of any additional torque-applying plate at circumference of said primary driving plate.

3. The torsion vibration damper of claim 1, wherein the toothed rim has a tooth width greater than 13 mm.

4. The torsion vibration damper of claim 1, wherein the toothed rim has a tooth width greater than 14 mm.

5. The torsion vibration damper of claim 1, wherein the toothed rim has a tooth width greater than 15 mm.

6. The torsion vibration damper of claim 1, wherein the toothed rim has a tooth width greater than 16 mm.

7. The torsion vibration damper of claim 1, wherein the toothed rim has a tooth width greater than 17 mm.

8. The torsion vibration damper of claim 1, wherein the toothed rim has a tooth width to tooth height ratio that is greater than 1.1.

9. The torsion vibration damper of claim 1, wherein the toothed rim has a tooth width to tooth height ratio that is greater than 1.2.

10. The torsion vibration damper of claim 1, wherein the toothed rim has a tooth width to rim diameter ratio that is greater than 0.05.

11. The torsion vibration damper of claim 1, wherein the toothed rim has a tooth width to rim diameter ratio that is greater than 0.052.

12. The torsion vibration damper of claim 1, wherein the toothed rim has a tooth width to rim diameter ratio that is greater than 0.053.

13. The torsion vibration damper of claim 1, wherein the toothed rim has a tooth width to rim diameter ratio that is greater than 0.055.

14. The torsion vibration damper of claim 1, wherein the toothed rim has a tooth width to rim diameter ratio that is greater than 0.058.
